(19) United States
(12) Patent Application Publication
(10) Pub. No.: US 2026/0034478 A1
(43) Pub. Date: Feb. 5, 2026

(54) SYSTEM AND METHOD FOR CONCENTRATING SUBSTANCE-CONTAINING FLUIDS BY MEANS OF MULTI-STAGE EVAPORATION

(71) Applicant: GIG Karasek GmbH, Gloggnitz (AT)

(72) Inventors: Edgar HUBER, Premstätten (AT); Andreas SCHNITZHOFER, Feldkirchen an der Donau (AT)

(73) Assignee: GIG Karasek GmbH, Gloggnitz (AT)

(21) Appl. No.: 19/108,916

(22) PCT Filed: Jul. 25, 2023
(86) PCT No.: PCT/AT2023/060247

§ 371 Date: Mar. 5, 2025

(30) Foreign Application Priority Data
Sep. 27, 2022 (AT) GM 50150/2022

(51) Int. Cl. B01D 1/28

(52) U.S. Cl. CPC B01D 1/2815; B01D 1/2843; B01D 1/2881

(57) ABSTRACT

System and method for concentrating substance-containing fluids by multi-stage evaporation. System includes at least a first and a second evaporator, the first evaporator being connected to the second evaporator, whereby fluid concentrated in the first evaporator is conducted into the second evaporator to further concentrate fluid in the second evaporator, a first mechanically acting compressor unit, whereby vapor formed in the first evaporator is compressed downstream, and a second mechanically acting compressor unit, whereby vapor formed in the second evaporator is compressed downstream. System includes a first supply line supplying vapor compressed with the first mechanically acting compressor unit to the first evaporator. Vapor compressed by the second compressor unit is supplied to the first compressor unit. First and second compressor units include pluralities of compressors and vapor in the second compressor unit is compressed to a larger outlet temperature minus inlet temperature difference than in the first compressor unit.

The invention relates to a system for the concentration of substance-containing fluids by multi-stage evaporation, in particular of solutions such as N-methylmorpholine-N-oxide (NMMO), wherein the system is configured with at least a first evaporator and a second evaporator, wherein the first evaporator is connected to the second evaporator in a suitable manner such that fluid concentrated in the first evaporator can be conducted into the second evaporator in order to further concentrate concentrated in fluid the second evaporator, wherein a first mechanically acting compressor unit is provided, with which vapour formed in the first evaporator can be compressed downstream, and wherein the system comprises a first supply line for supplying vapour compressed with the first mechanically acting compressor unit to the first evaporator.

Furthermore, the invention relates to a method for the concentration of substance-containing fluids by multi-stage evaporation, for example of solutions such as NMMO, in particular with a device of the type defined above, wherein the fluid is concentrated in a first evaporator and the fluid concentrated in this manner is conducted into a second evaporator, in which the concentrated fluid is concentrated further, after which a concentrate is removed, wherein vapour formed in the first evaporator is compressed downstream with a first mechanically acting compressor unit and supplied at least in part to the first evaporator via a first supply line.

In the context of the invention, the term “substance-containing fluids” should be understood to mean fluids which, in addition to the fluid, have a substance which is dissolved therein, entrained thereby or is present in another form therein, for example salt-containing fluids, fluids with dissolved polar organic molecules or oligomers, as well as polymers or other fluids which can be concentrated with respect to the contained substance.

NMMO or other fluids such as ionic fluids are employed as solvents, inter alia in order to dissolve cellulose for subsequent applications. Lyocell fibres, films or other products, for example, can be produced from an appropriate solution. In particular, NMMO has the advantage of being neither toxic nor strong-smelling, and is therefore employed preferentially. For this reason and for environmental protection reasons, it is also desirable to recover solvents for the process and therefore to be able to supply it to the process in as pure a state as possible. In this regard, it is necessary to concentrate appropriate solvents in a manner such that the appropriate solution can be used again for the respective process.

In order, for example, to be able to re-supply NMMO to a process for the production of Lyocell fibres, US 2011/0226427 A1 shows that it is known to re-use vapour, which is obtained by the concentration of NMMO in a solution, in order to be able to operate in a way that is as energy-saving as possible. In this regard, vapour taken off from an evaporator is compressed, and in fact by means of a mechanical compression.

In general, in order to concentrate substance-containing solutions, it is known to use multi-stage methods with a plurality of evaporators. As an example, a pre-concentration may be carried out in a first evaporator, after which a further concentration is carried out in a second evaporator, preferably equivalent to a finisher. An appropriate example is provided in DE 10 2012 203 439 A1. Here, as a rule, the first evaporator is operated in a manner such that vapour emerging from the evaporator is brought to a higher temperature by means of mechanical compression and is then re-supplied to the evaporator in order to be able to operate in a manner which conserves as much energy as possible. The second evaporator should also be operated in a manner which is as energy-efficient as possible. However, the concentration in the first evaporator regularly results in the concentrated solution having a substantially higher boiling point than the much less concentrated solution present in the first evaporator. Consequently, an increased energy expenditure is necessary in order to operate the second evaporator in a manner such that the desired concentration can be carried out in the second step, usually a final step. Thus, as disclosed in the cited document DE 10 2012 203 439 A1, it is necessary to operate the second evaporator either with separately produced fresh vapour or to provide thermal compression, wherein both consume substantially more energy than mechanical compression.

This is the starting point for the invention. The objective of the invention is to further develop a device of the aforementioned type in a manner such that it can be operated more energy-efficiently, in particular with the possibility of being capable of operating entirely or in part without thermal compression.

A further objective of the invention is to further develop a method of the aforementioned type in a manner such that it can be carried out in an energy-efficient manner, in particular without being forced to employ thermal compression.

The objective of the invention is achieved when, in a device of the aforementioned type, a second mechanically acting compressor unit is provided, with which vapour formed in the second evaporator can be compressed downstream, wherein vapour compressed by the second compressor unit can be supplied to the first compressor unit.

An envisaged advantage of the invention is that the system is configured in a manner such that a concentration of substance-containing fluids, in particular a fluid containing NMMO, but also ionic fluids, is possible with relatively simple means. This means that NMMO solutions in particular can be concentrated effectively and in an energy-efficient manner and therefore, for example, can be regenerated in a process for the production of Lyocell fibres and then re-supplied to this process.

Although it is not mandatory, a device in accordance with the invention may be operated without a thermal compressor. In particular, it is also not absolutely necessary to supply fresh vapour to the second evaporator in which, as a rule, a final concentration takes place. To this end, the system is designed so that vapour generated in the second evaporator is compressed with a second mechanically acting compressor unit and thereafter supplied in its entirety or at least in part to the first mechanically acting compressor unit, so that a further compression of the already-compressed vapour from the second evaporator is carried out. Next, the vapour which has been compressed in this manner is supplied to the first evaporator as well as to the second evaporator, wherein the finally compressed vapour is divided into suitable partial streams.

The following considerations underlie the design of the system in accordance with the invention: NMMO solutions and the like constitute resources in a production process which are valuable and therefore should be recycled. In processes such as a Lyocell process, for example, such solutions occur with a low NMMO content of approximately 20% (as a percentage by weight, hereinafter abbreviated to % by wt), for example. In order to be able to re-supply such solutions to the actual production process, the solution needs to be concentrated to approximately 80% by wt, for example. However, concentration cannot be carried out in an energy-efficient manner in a single evaporator, but has to be carried out in technically successive compression steps to a desired final concentration of NMMO. The problem here is that the increase in the boiling point with increasing NMMO concentration in the fluid is considerable. If, for example, a two-stage process is operated with two evaporators, the boiling temperature in the first evaporator may be approximately 120° C., whereas in the second evaporator, which has a substantially higher NMMO concentration, the boiling temperature may be approximately 145° C. This means that substantially more energy has to be supplied in the second evaporator in order to withdraw vapour and therefore to obtain concentration. While, according to the prior art, in the first evaporator, vapour can be withdrawn, compressed and re-supplied to the first evaporator, this is not possible with the second evaporator, because the vapour emerges at a relatively low temperature of approximately 85° C. to 90° C. and any mechanical compression and the corresponding temperature rise of the vapour is not sufficient to be able to supply sufficient energy to the second evaporator for concentration. Thus, according to the prior art, powerful thermal compressors are provided for the second evaporator, or alternatively, they are additionally or exclusively operated with separately supplied fresh vapour as well. In contrast to this, in accordance with the invention, a second mechanical compressor unit is now provided for vapour from the second compressor, wherein compressed vapour from the second mechanical compressor unit is initially supplied to the first compressor unit before the vapour which has been finally compressed in this manner is divided into partial streams and is supplied to the first evaporator on the one hand and to the second evaporator on the other hand. This action means that vapour withdrawn from the second evaporator is not only compressed with the second compressor unit, but also with the first compressor unit. With a suitable configuration, the second compressor unit can provide vapour with a temperature increase of circa 30° C., which is not yet sufficient for the second evaporator. By supplying the vapour compressed by the second compressor unit to the first compressor unit, however, a further upwards jump in temperature can be obtained, so that the temperature is sufficient for an operation of the second evaporator and the vapour brought to temperature in this manner can also be supplied to the second evaporator at a suitable temperature. By means of the appropriate circuitry, a consumption of energy for the operation of the two evaporators, and therefore of the system as a whole, is minimised.

It may be the case that the first compressor unit comprises a plurality of compressors. Expediently, the individual compressors are connected in series. Preferably, the first compressor unit has two to four, in particular two or three compressors in order to obtain the desired rise in temperature for the vapour taken from the first evaporator as well as for already-compressed vapour supplied from the second evaporator. Furthermore, if required, parallel connections of a plurality of separate compressor units may be envisaged, which in turn may comprise a plurality of compressors, wherein all or part of the vapour from the second compressor unit is supplied to at least one of these compressors.

The second compressor unit may also comprise a plurality of compressors. The number of compressors in the second compressor unit is in turn appropriate to the design of the system. In principle, it is sufficient for the second compressor unit to have two or three compressors which are connected in series, in analogous manner to the first compressor unit. In both compressor units, the compressors may be configured as known vapour recompressors. Furthermore, if necessary, here again, parallel connections of a plurality of separate compressor units may be envisaged, which in turn may respectively comprise a plurality of compressors.

Compressed vapour from the first mechanically acting compressor unit, which also comprises the further-compressed vapour from the second mechanically acting compressor unit, is then reused in the process in order to heat the first evaporator as well as the second evaporator. To this end, the system comprises a second supply line for supplying vapour compressed with the first mechanically acting compressor unit to the second evaporator.

In principle, in the case of the system in accordance with the invention, a thermal compressor is not provided. Nevertheless, under certain circumstances, it may be necessary to additionally provide the second evaporator with a thermal compressor of small dimensions, although this should in principle be avoided.

The second evaporator is preferably configured as a finisher, from which the concentrated substance-containing fluid is withdrawn from the system. Although the system may have more than two evaporators, for most purposes it is sufficient for the system to be configured with a first evaporator for pre-concentration and a second evaporator as a finisher for obtaining a final concentration.

The objective associated with the method is achieved when, in a method of the aforementioned type, vapour formed in the second evaporator is compressed downstream with a second mechanically acting compressor unit and then supplied to the first compressor unit.

In accordance with the concept of the invention, it is therefore possible for the evaporators which are provided to be brought to the required temperature with a minimised expenditure of energy. This is possible because vapour withdrawn from the second evaporator is initially compressed with the second mechanically acting compressor unit with a first increase in temperature, and then further compressed with the first mechanically acting compressor unit and brought to a yet higher temperature, so that after final compression, suitable partial streams can be formed for heating the evaporators.

The vapour compressed in the second evaporator may be compressed in the first mechanically acting compressor together with the vapour formed in the first compressor, so that at the end of the first mechanically acting compressor unit, a combined stream of vapour is generated from the two vapour fractions withdrawn from the first evaporator and from the second evaporator, which then can be divided into a first partial stream for the first evaporator and a second partial stream for the second evaporator.

Vapour formed in the first evaporator may be compressed downstream using a plurality of compressors of the first mechanically acting compressor unit. In addition, a plurality of compressors may be provided in the case of the second compressor unit. The number of compressors is designed so that on the one hand, the desired increase in temperature is obtained for resupplying the vapour to the evaporator, but on the other hand, the energy expenditure is minimised.

In the context of the invention, the vapour in the second compressor unit may be compressed to a higher outlet temperature minus inlet temperature difference than in the first compressor unit. As a rule, it is necessary for the vapour emerging from the second evaporator to undergo a larger temperature rise, because in the second evaporator, not only is a higher energy supply necessary, but also, the vapour is taken off at a lower temperature.

In the context of the invention, as a rule, the first evaporator is operated at a higher pressure than the second evaporator.

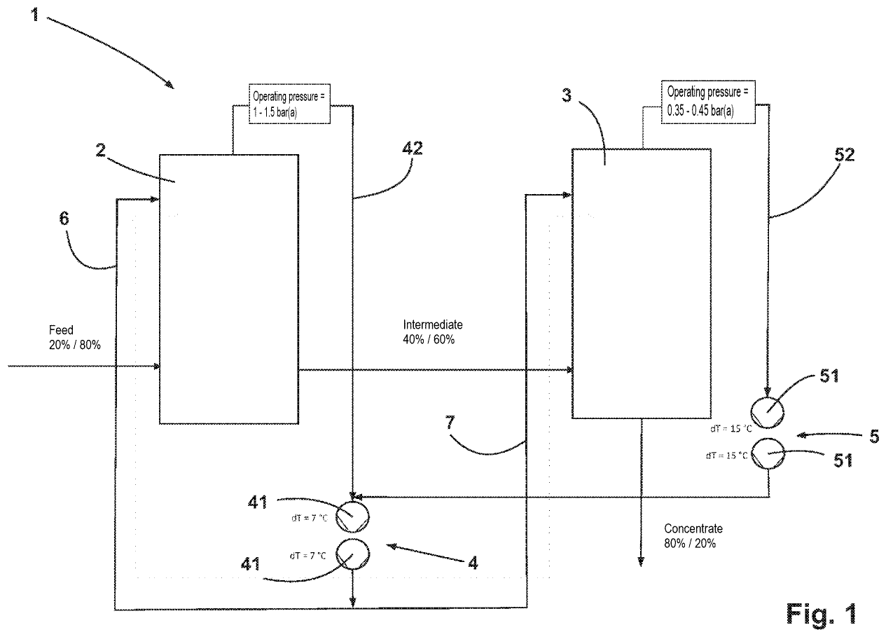

Further features, advantages and effects of the invention will become apparent from the exemplary embodiment described below. In the drawing, FIG. 1 shows a system design in accordance with the invention.

FIG. 1 shows a system 1 which is designed for concentrating NMMO. The system 1 comprises a first evaporator 2 and a second evaporator 3. An aqueous solution of NMMO is introduced into the evaporator circuit for the purposes of concentrating the solution. The NMMO solution is supplied to the first evaporator 2 for pre-concentration at a NMMO content of 20% by wt, for example. In the first evaporator 2, the temperature of the supplied NMMO solution is raised by supplying energy. The vapour which is generated thereby can be taken off overhead in the first evaporator 2. The pre-concentrated NMMO solution is taken from the bottom and supplied to the second evaporator 3 in which, in turn, the temperature of the supplied solution is raised so that in turn, vapour can be withdrawn overhead from the second evaporator 3 and so that in turn, an increase in concentration occurs and finally, a NMMO solution with 80% by wt NMMO can be taken off from the bottom of the second evaporator 3, which serves as a finisher.

The vapour emerging from the first evaporator 2 is reused in the further process. To this end, a first mechanically acting compressor unit 4 is provided. The first compressor unit 4 comprises a plurality of individual compressors 41. In the exemplary embodiment, the first compressor unit 4 comprises two compressors 41. The two compressors 41 of the first compressor unit 4, which are connected in series, are connected to the first evaporator 2 via a first take-off line 42. In similar manner, the second evaporator 3 is designed with a take-off line 52, which connects an overhead outlet from the second evaporator 3 to a second mechanically acting compressor unit 4. The second compressor unit 5 also comprises two individual compressors 51. The compressors 51 of the second compressor unit 5 are also connected in series.

As can be seen in FIG. 1, the compressors 51 of the second compressor unit 5 are equipped with a downstream line which discharges into the take-off line 42 of the first evaporator 2. Vapour compressed with the second compressor unit 5 is therefore combined with the vapour taken off from the first evaporator 2 before the vapour combined in this manner is compressed further in the first compressor unit 4. After this final compression, the compressed vapour is divided into two partial streams, namely a first partial stream for a first supply line 6 to the first evaporator 2, as well as a second supply line 7 to the second evaporator 3.

By means of the circuitry which is provided, it is possible for vapour from the second evaporator 3, which emerges at a relatively low temperature of approximately 30° C. lower than in the first evaporator 2, to initially be brought to a temperature which is approximately 30° C. to 40° C. higher with the compressors 51 of the second compressor unit 5 which are provided. This alone would not yet be a sufficient temperature for the operation of the second evaporator 3. By the additional compression with the first compressor unit 4, however, a further temperature rise of several ° C. is obtained, so that a temperature of the compressed vapour is sufficient to heat the second evaporator 3 sufficiently. Thus, a minimum number of mechanically acting compressors is sufficient to result in an energetically effective process. As can be seen in FIG. 1, in the first evaporator 3, the NMMO solution can be concentrated to approximately 40% by wt NMMO thereby and in the second, to a final 80% by wt NMMO.

1. A system for the concentration of substance-containing fluids by multi-stage evaporation, in particular of solutions such as N-methylmorpholine-N-oxide (NMMO), wherein the system is configured with at least a first evaporator and a second evaporator, wherein the first evaporator is connected to the second evaporator in a suitable manner such that fluid concentrated in the first evaporator can be conducted into the second evaporator in order to further concentrate concentrated fluid in the second evaporator, wherein a first mechanically acting compressor unit is provided, with which vapor formed in the first evaporator can be compressed downstream, and wherein the system comprises a first supply line for supplying vapor compressed with the first mechanically acting compressor unit to the first evaporator, wherein a second mechanically acting compressor unit is provided, with which vapor formed in the second evaporator can be compressed downstream, wherein vapor compressed by the second compressor unit can be supplied to the first compressor unit, wherein the first compressor unit comprises a plurality of compressors and the second compressor unit comprises a plurality of compressors, wherein vapor in the second compressor unit is compressed to a larger outlet temperature minus inlet temperature difference than in the first compressor unit.

2.-3. (canceled)

4. The system as claimed in claim 1, wherein the system comprises a second supply line for supplying vapor compressed with the first mechanically acting compressor unit to the second evaporator.

5. The system as claimed in claim 1, wherein a thermal compressor is not provided.

6. The system as claimed in claim 1, wherein the second evaporator is configured as a finisher, from which the concentrated fluid is withdrawn from the system.

7. A method for the concentration of substance-containing fluids by multi-stage evaporation, for example of solutions such as N-methylmorpholine-N-oxide (NMMO), in particular with a device as claimed in claim 1, wherein the fluid is concentrated in a first evaporator and the fluid concentrated in this manner is conducted into a second evaporator, in which the concentrated fluid is concentrated further, after which a concentrate is removed, wherein vapor formed in the first evaporator is compressed downstream with a first mechanically acting compressor unit and supplied at least in part to the first evaporator via a first supply line, wherein vapor formed in the second evaporator is compressed downstream with a second mechanically acting compressor unit and then supplied to the first compressor unit, wherein vapor in the second compressor unit is compressed to a higher outlet temperature minus inlet temperature difference than in the first compressor unit.

8. The method as claimed in claim 7, wherein the vapor compressed in the second evaporator is compressed in the first mechanically acting compressor unit together with the vapor formed in the first evaporator.

9. The method as claimed in claim 7, wherein vapor compressed in the first mechanically acting compressor unit is divided into partial streams, wherein one partial stream is supplied to the first evaporator and a further partial stream is supplied to the second evaporator.

10. The method as claimed in claim 7, wherein vapor formed in the second evaporator is compressed downstream with a plurality of compressors of the second mechanically acting compressor unit.

11. The method as claimed in claim 7, wherein vapor formed in the first evaporator is compressed downstream with a plurality of compressors of the first mechanically acting compressor unit.

12. The method as claimed in claim 7, wherein the first evaporator is operated at a higher pressure than the second evaporator.

13. (canceled)
